(19) United States
(12) Patent Application Publication
(10) Pub. No.: US 2026/0218454 A1
(43) Pub. Date: Jul. 30, 2026

(54) CARBON MATERIAL PRECURSOR AND METHOD FOR PRODUCING CARBON MATERIAL USING SAME

(71) Applicant: NIPPON PAPER INDUSTRIES CO., LTD., Tokyo (JP)

(72) Inventors: Minoru YADA, Tokyo (JP); Tatsunori ITO, Tokyo (JP); Koji FUKAZAWA, Tokyo (JP); Yoshihide WATANABE, Tokyo (JP)

(73) Assignee: NIPPON PAPER INDUSTRIES CO., LTD., Tokyo (JP)

(21) Appl. No.: 19/573,425

(22) Filed: Mar. 20, 2026

Related U.S. Application Data
(63) Continuation of application No. PCT/JP2024/034062, filed on Sep. 25, 2024.

(30) Foreign Application Priority Data
Sep. 27, 2023 (JP) 2023-164723

(51) Int. Cl. D21H 13/26; C01B 32/05; D21H 11/04

(52) U.S. Cl. CPC D21H 13/26; C01B 32/05; D21H 11/04

(57) ABSTRACT

A problem is to provide a carbon material precursor that undergoes little shrinkage upon carbonization treatment, the carbon material precursor including, as a main component, cellulosic fibers, which are a sustainable biomass resource. Furthermore, another problem is to provide a method of manufacturing a carbon material enabling reduction in shrinkage upon carbonization treatment even if a precursor including cellulosic fibers as a main component is used.

A carbon material precursor including an unfired fiber mixture of cellulosic fibers and synthetic polymer fibers is prepared, a content of the cellulosic fibers in the unfired fiber mixture being 50% by weight or more, a content of the synthetic polymer fibers in the unfired fiber mixture being 5% by weight or more and less than 50% by weight. As the synthetic polymer fibers, synthetic polymer fibers that have a thermal decomposition temperature higher than a thermal decomposition temperature of the cellulosic fibers and do not melt at the thermal decomposition temperature of the cellulosic fibers or lower are used. A carbon material is obtained by firing such a carbon material precursor.

### CROSS-REFERENCE TO RELATED APPLICATIONS

This application is based upon and claims the benefits of priority(ies) from Japanese Patent Application No. 2023-164723, filed on Sep. 27, 2023; and International Application No. PCT/JP2024/034062, filed Sep. 25, 2024, the entire contents of which are incorporated herein by reference.

### TECHNICAL FIELD

The present disclosure relates to a carbon material precursor and a method of manufacturing a carbon material using the carbon material precursor.

### BACKGROUND ART

Carbon fiber materials, such as carbon fiber sheets, have been used for a wide range of purposes, such as reinforcements and gas diffusion electrodes. In general, precursors of carbon fiber materials are mainly synthetic polymer fibers. However, synthetic polymer fibers are petrochemical products reliant on fossil resources and there is thus a demand for improvement in light of the recent rising global awareness of sustainable development.

In contrast to synthetic polymer fibers reliant on fossil resources, there are natural fibers, such as cellulosic fibers represented by natural pulp, which are fiber materials derived from sustainable biomass resources. Using natural pulp as a component of precursors of carbon materials has been attempted to date. For example, manufacturing a porous carbon sheet by carbonizing a precursor fiber sheet including short carbon fibers, resin, and pulp has been proposed (for example, Patent Literature 1). Furthermore, with the aim of reducing appearance defects generated when commonly used natural pulp is used, a precursor fiber sheet has been proposed as a precursor of a carbon material (porous carbon sheet), the precursor fiber sheet including short carbon fibers having a mean length ranging from 3 to 10 mm, natural pulp having an ash content of 0.15% by mass or less, and a resin that carbonizes when heated (Patent Literature 2).

### CITATION LIST

### Patent Literature

Patent Literature 1: Japanese Patent Application Laid-open No. 2011-195374
Patent Literature 2: Japanese Patent No. 5988009

### SUMMARY OF INVENTION

### Technical Problem

Some proposals have been made to use cellulosic fibers, such as natural pulp, for precursors of carbon fiber materials, but cellulosic fibers are used when they are mixed with already carbonized carbon fibers and subjected to firing again, and cellulosic fibers are thus often added as an auxiliary in a sense. The inventors attempted to obtain a carbon material by firing a precursor sheet including cellulosic fibers as a main component and encountered a problem that when the precursor sheet prepared from cellulosic fibers was subjected to carbonization treatment, the precursor sheet shrank significantly upon the carbonization treatment and lacked shape stability.

In view of the above circumstances, one of problems to be solved is to provide a carbon material precursor that undergoes little shrinkage upon carbonization treatment, the carbon material precursor including, as a main component, cellulosic fibers, which are a sustainable biomass resource.

Furthermore, another one of the problems to be solved is to provide a method of manufacturing a carbon material enabling reduction in shrinkage upon carbonization treatment even if a precursor including cellulosic fibers as a main component is used.

### Solution to Problem

The inventors have diligently conducted research and found a temperature range where cellulosic fibers shrink significantly during firing of the cellulosic fibers. On the basis of this finding, the inventors conceived the idea of allowing another component to coexist with the cellulosic fibers, the other component being suitable for reducing the shrinkage of the cellulosic fibers in that temperature range.

The invention presented by the present disclosure can be understood versatilely through various aspects and, for example, may include embodied aspects as solutions to the problems, as follows. In the present disclosure, the invention presented by the present disclosure may simply be referred as to “the present invention” comprehensively and conceptually or according to the individual aspects.

[1] A carbon material precursor, comprising:
an unfired fiber mixture of cellulosic fibers and synthetic polymer fibers;
a content of 50% by weight or more of the cellulosic fibers in the unfired fiber mixture;
a content of 5% by weight or more and less than 50% by weight of the synthetic polymer fibers in the unfired fiber mixture; and
the synthetic polymer fibers having a thermal decomposition temperature higher than a thermal decomposition temperature of the cellulosic fibers, and remaining unmelted at the thermal decomposition temperature of the cellulosic fibers or lower.

[2] The carbon material precursor according to [1] above, wherein the cellulosic fibers include any one selected from or both of chemical pulp and mechanical pulp.

[3] The carbon material precursor according to [1] above, wherein the thermal decomposition temperature of the synthetic polymer fibers is 350° C. or higher in an inert gas atmosphere, at a heating rate of 10° C./min.

[4] The carbon material precursor according to [1] above, wherein the synthetic polymer fibers have a melting point of 350° C. or higher or have no observed melting point.

[5] The carbon material precursor according to any one of [1] to [4] above, wherein the synthetic polymer fibers are one type or two or more types selected from a group consisting of aramid fibers, polyether ether ketone fibers, polyimide fibers, and polyphenylene sulfide fibers.

[6] A method of manufacturing a carbon material, the method including:
a process of firing a carbon material precursor, wherein
the carbon material precursor includes an unfired fiber mixture of cellulosic fibers and synthetic polymer fibers, a content of the cellulosic fibers in the unfired fiber mixture is 50% by weight or more, and a content of the synthetic polymer fibers in the unfired fiber mixture is 5% or more and less than 50%, and
the synthetic polymer fibers have a thermal decomposition temperature higher than a thermal decomposition temperature of the cellulosic fibers and do not melt at the thermal decomposition temperature of the cellulosic fibers or lower.

[7] The method of manufacturing the carbon material, according to [6] above, wherein the carbon material precursor is sheet-shaped and the carbon material is a carbon fiber sheet.

[8] The method of manufacturing the carbon material, according to [6] above, wherein the firing is performed at a temperature ranging from 700 to 2500° C.

[9] The method of manufacturing the carbon material, according to any one of [6] to [9] above, wherein in the process of firing, a heating rate up to a highest temperature is 45° C./min or less.

### Advantageous Effects of Invention

In one or more aspects of the invention presented by the present disclosure, a precursor can be provided, the precursor enabling reduction in extent of shrinkage upon carbonization treatment even if the precursor is a carbon material precursor including, as a main component, cellulosic fibers, which are a sustainable biomass resource.

In one or more aspects of the invention presented by the present disclosure, a method of manufacturing a carbon material can be provided, the method enabling reduction in shrinkage upon carbonization treatment even if a precursor including cellulosic fibers as a main component is used.

### DESCRIPTION OF EMBODIMENTS

The present disclosure is made through an international application based on the Patent Cooperation Treaty and is made in Japanese language at the time of filing the application. Upon entry to designated states and elected states, the present disclosure is planned to be translated into languages required by these states. In the present disclosure, unless otherwise stated, nouns in Japanese language may be singular or plural in accordance with the full text or the context of the present disclosure. Furthermore, upon translation into a language, such as English language having countable nouns and uncountable nouns and countable nouns each have a singular form and a plural form that are distinguished from each other, the singular form includes plural cases and the plural form includes singular cases in accordance with the full text or the context of the present disclosure, unless otherwise stated.

Embodiments of the present invention will be described hereinafter.

In the present disclosure, unless otherwise specified, the term, “an embodiment,” in relation to the present invention refers to an optional embodiment for description of the present invention in detail and does not deny or limit the presence of another or other embodiments. As described hereinafter, multiple embodiments may be included in the scope of the present invention. The multiple embodiments may be provided, for example, in modified forms through combination of components (or technical features) disclosed herein in various ways. Furthermore, “embodiments” simply referred to in the present disclosure include, unless otherwise specified, one or more embodiments.

In the present disclosure, the phrase, “ranging from AA to BB,” in relation to a numerical range means “being in the range of AA or more and BB or less,” (where “AA” and “BB” are any numerical values) unless otherwise specified. Furthermore, the units of the lower limit and the upper limit are both the same as the unit written immediately after the upper limit (that is, “BB” herein), unless otherwise specified. Furthermore, as a combination of a lower limit value and an upper limit value of a numerical range in the present disclosure, a combination of numerical values can be selected optionally from a group of numerical values including lower limit values and upper limit values described as examples of preferred numerical values. Furthermore, the expression, “X and/or Y” means both X and Y, or either X or Y.

### 1. Carbon Material Precursor

In an embodiment of the present invention, a carbon material precursor that enables reduction in extent of shrinkage after carbonization is provided even if the carbon material precursor includes cellulosic fibers as a main component. In the present disclosure, a carbon material precursor means a precursor including a material that has not been subjected to carbonization treatment through firing yet. Furthermore, in the present disclosure, a simple reference to “cellulosic fibers” means unfired cellulosic fibers.

A carbon material precursor that is an embodiment of the present invention includes cellulosic fibers and another unfired material that may reduce shrinkage of the cellulosic fibers. Cellulose has a thermal decomposition temperature ranging from 250 to 400° C. and extent of the shrinkage of the cellulosic fibers is increased in this temperature range. A material that is ultimately fired and carbonized and is less likely to shrink than the cellulosic fibers in the thermal decomposition temperature range of cellulose is used as the other unfired material. Examples of the other unfired material may include synthetic polymer fibers having given thermal properties. In the present disclosure, a simple reference to “synthetic polymer fibers” means unfired synthetic polymer fibers. In the present disclosure, mixed fibers including the cellulosic fibers and the synthetic polymer fibers are referred to as an unfired fiber mixture.

In the present disclosure, including cellulosic fibers as a main component means that at least the content of the cellulosic fibers is higher than that of any other component and from the viewpoint of sustainability, a higher content of the cellulosic fibers is preferable. Examples of numerical values of the lower limit of the content of the cellulosic fibers in all of the unfired materials (or in the unfired fiber mixture) may be preferably 50, 51, 52, 53, 54, or 55% by weight or more, more preferably 60, 65, or 68% by weight or more, and even more preferably 70, 75, or 78% by weight or more.

However, from the viewpoint of reducing shrinkage upon carbonization treatment, the amount of the cellulosic fibers may be relatively reduced. For example, in a case where an unfired fiber mixture including cellulosic fibers and synthetic polymer fibers is used, the content of the cellulosic fibers in the unfired fiber mixture may vary depending on the types of the synthetic polymer fibers, but the content may be 95, 90, 85, 83, 82, 81, or 80% by weight or less. Furthermore, in a case where the shrinkage is desired to be reduced further, or with the aim of modifying characteristics of the carbonized material obtained by the firing, the content of the cellulosic fibers may be reduced to less than 80% by weight.

In a case where given synthetic polymer fibers are used as the other unfired material for reducing the shrinkage of the cellulosic fibers, the content of the synthetic polymer fibers in the unfired fiber mixture may be preferably 5% by weight or more and less than 50%. More specifically, the content of the synthetic polymer fibers is as follows.

The lower limit of the content of the synthetic polymer fibers in the unfired fiber mixture may vary depending on the types of the synthetic polymer fibers, but from the viewpoint of reducing the shrinkage of the cellulosic fibers, the lower limit may be preferably 5% by weight or more, more preferably 108 by weight or more, and even more preferably 15% or more.

The content of the synthetic polymer fibers may be higher than the above mentioned lower limit values from the viewpoint of further reducing the shrinkage upon carbonization treatment, but in view of the lower limit of the content of the cellulosic fibers, the content of the synthetic polymer fibers may be preferably up to less than 50% by weight. The content of the cellulosic fibers may be relatively increased, and the content of the synthetic polymer fibers in the unfired fiber mixture may be 45, 40, 30, or 20% by weight or less.

Synthetic polymer fibers having given thermal properties may be used as the synthetic polymer fibers that contribute to reduction of the shrinkage of the cellulosic fibers upon carbonization treatment. Examples of an index representing a thermal property of the synthetic polymer fibers may include a thermal decomposition temperature and a melting point. In an embodiment of the present invention, one or a combination of two or more of these thermal property indices may be adopted.

For example, a precursor satisfying the following conditions (a) to (e) may be a preferred embodiment of a carbon fiber precursor.
(a) An unfired fiber mixture of cellulosic fibers and synthetic polymer fibers is included.
(b) The content of the cellulosic fibers in the unfired fiber mixture is 50% by weight or more.
(c) The content of the synthetic polymer fibers in the unfired fiber mixture is 5% by weight or more and less than 50% by weight.
(d) The synthetic polymer fibers have a thermal decomposition temperature higher than a thermal decomposition temperature of the cellulosic fibers.
(e) The synthetic polymer fibers do not melt at the thermal decomposition temperature of the cellulosic fibers or lower.

Cellulosic fibers in a carbon material precursor that is an embodiment of the present invention are used as a material included in the precursor. In the present disclosure, “cellulosic fibers” refers to fibers including, as main components, cellulose and derivatives of cellulose. As described below, the cellulosic fibers may be cellulosic fibers that have been denatured. Cellulose and derivatives of cellulose are carbohydrates (polysaccharides) that are main components of plant cell walls and plant fibers, account for ⅓ of natural plant materials, and are the most abundant biological resource (biomass) on Earth. That is, the present disclosure provides various means for effectively utilizing cellulosic fibers, which are an abundantly available and sustainable biomass resource, and provides a technique that may contribute to sustainable development and contribute also to reduction of the manufacturing cost of carbon materials.

Cellulosic fibers that may be used in an embodiment of the present invention include fibers of cellulose and fibers of cellulose derivatives. The cellulose derivatives fall within the category of cellulose derivatives as long as they retain, in their molecules, a structure in which D-glucopyranose units are linked by β-1,4 bonds (cellulose backbone). Cellulose normally has linear chains, but the cellulose derivatives may have substituents, may have side chains, and/or may be branched with respect to cellulose. Unless explicit distinction is particularly needed, cellulose and derivatives of cellulose will hereinafter be simply referred to as “cellulose” in the present disclosure.

Examples of materials that may be used as the cellulosic fibers may include chemical pulp for papermaking, mechanical pulp, cotton, natural cellulosic fibers, such as fibers derived from herbaceous plants, and regenerated cellulosic fibers, such as viscose rayon. In a preferred embodiment of the disclosure, for example, natural fibers are suitable as the cellulosic fibers, and more specifically, examples of the cellulosic fibers may include chemical pulp, mechanical pulp, cotton, and fibers derived from herbaceous plants. Pulp, such as chemical pulp and mechanical pulp, is able to be mass-produced in the paper manufacturing industry as raw materials for various types of paper and may be suitable from the viewpoint of reducing the raw material cost. One type of cellulosic fibers may be used or a combination of two or more types of cellulosic fibers may be used.

In a preferred embodiment of the present invention, chemical pulp may be used alone as the cellulosic fibers. Chemical pulp is generally refined pulp or has less impurities, such as inorganic substances and lignin, than mechanical pulp, because chemical pulp is prepared by subjecting woody biomass resources to chemical treatment. Chemical pulp has little ash originating from inorganic substances and when chemical pulp is subjected to firing, a carbon material comparatively high in carbon purity and high in chemical stability can be obtained. Furthermore, the chemical pulp manufacturing process has long employed chemical recycling and energy recovery and chemical pulp thus can be obtained by a method with a low environmental load.

Furthermore, in another preferred embodiment of the present invention, mechanical pulp may be used alone as the cellulosic fibers. Mechanical pulp has a higher density as a carbon material precursor than chemical pulp, and thus has a comparatively high density after being fired, and for carbon materials, in particular, carbon fiber sheets, improvement in strength can thus be expected. Furthermore, large amounts of fuzz and short fibers are generated in a process of manufacturing mechanical pulp, precursor sheets obtained by papermaking are thus comparatively smooth, and carbon fiber sheets that have been subjected to firing can thus also be expected to be smooth. Furthermore, mechanical pulp can be prepared from woody biomass resources through physical treatment, such as grinding and cutting, is high in yield, and thus is also suitable costwise. Furthermore, because substances including lignin and naturally present in woody tissue still remain in mechanical pulp, improvement in yield after firing can also be expected.

Furthermore, in another preferred embodiment of the present invention, a mixture of chemical pulp and mechanical pulp may be used as the cellulosic fibers. The chemical pulp and mechanical pulp respectively have the above described characteristics, and the mixing ratio of these types of pulp may be adjusted according to uses of the carbon material and desired performance required for the carbon material.

As a preferred embodiment, a carbon material precursor of the present disclosure contains another unfired material that may reduce shrinkage of the cellulosic fibers upon carbonization treatment. A material that is ultimately fired and carbonized and is less likely to shrink than the cellulosic fibers in the thermal decomposition temperature range of cellulose is suitable as the other unfired material, for example. More specifically, preferred examples of the other unfired material may include synthetic polymer fibers having given thermal properties. Examples of the given thermal properties that may serve as indices may include a thermal decomposition temperature and a melting point.

As a preferred embodiment of the other unfired material, synthetic polymer fibers that have a thermal decomposition temperature higher than the thermal decomposition temperature of the cellulosic fibers used with the other unfired material and do not melt at the thermal decomposition temperature of the cellulosic fibers or lower may be used. Mixing such synthetic polymer fibers with the cellulosic fibers is thought to cause the synthetic polymer fibers to act as a support to reduce the shrinkage of the cellulosic fibers in the temperature range where the cellulosic fibers tend to shrink.

As described above, the extent of the shrinkage of the cellulosic fibers increases in their thermal decomposition temperature range. The thermal decomposition temperature of the cellulosic fibers is about 250 to 400° C. In the present disclosure, being higher than the thermal decomposition temperature of the cellulosic fibers does not mean that being 400° C. or higher is always essential. The temperature may just be higher than the thermal decomposition temperature of the specific cellulosic fibers used therewith. For example, in a case where cellulosic fibers having a thermal decomposition temperature of around 300° C. are used, synthetic polymer fibers to be mixed with the cellulosic fibers may just have a thermal decomposition temperature higher than a temperature around 300° C. With a certain allowance, using a material having a thermal decomposition temperature higher than the thermal decomposition temperature of the cellulosic fibers used with the material by about 10 to 50° C. may be suitable in practice.

As to examples described herein using numerical values specifically, the thermal decomposition temperature of the synthetic polymer fibers may be preferably 350° C. or higher, more preferably 380° C. or higher, and even more preferably 400° C. or higher, in an inert gas atmosphere, at a heating rate of 10° C./min. Using the synthetic polymer fibers having the thermal decomposition temperature higher than the above mentioned lower limits is suitable for further reducing the shrinkage of the cellulosic fibers upon carbonization treatment.

For some polymer materials, such as cellulosic fibers and synthetic polymer fibers, it may be difficult to determine a single thermal decomposition temperature even for a single product, and in light of the common technical knowledge in the relevant technical field, their thermal decomposition temperatures may be determined within certain numerical ranges. In a case where one or both of the thermal decomposition temperature of the cellulosic fibers and the thermal decomposition temperature of the synthetic polymer fibers is/are represented by a numerical range or numerical ranges, a comparison using the thermal decomposition temperature as an index may be made using the numerical ranges of both of them or the numerical range of one of them. In such a case, in a preferred embodiment of the present invention, the largest value (or the upper limit value) of the numerical range can be used for comparison with respect to the thermal decomposition temperature of the cellulosic fibers and the smallest value (or the lower limit value) of the numerical range can be used for comparison with respect to the thermal decomposition temperature of the synthetic polymer fibers.

In an embodiment of the present invention, as described above, synthetic polymer fibers that do not melt at the thermal decomposition temperature of the cellulosic fibers used with the synthetic polymer fibers or lower may be used as the synthetic polymer fibers. From this viewpoint, a melting point (Tm) may be used as an index of another thermal property related to the synthetic polymer fibers. The melting point of the synthetic polymer fibers may be preferably 350° C. or higher. More specifically, the melting point is as follows.

The lower limit of the melting point of the synthetic polymer fibers may be preferably 350° C. or higher, more preferably 375° C. or higher, and even more preferably 400° C. or higher. The lower limit of the melting point of the synthetic polymer fibers being at the above mentioned lower limits or higher is suitable for reducing shrinkage of the cellulosic fibers upon carbonization treatment.

The upper limit of the melting point of the synthetic polymer fibers does not need to be particularly determined from the viewpoint of reducing the shrinkage of the cellulosic fibers upon carbonization treatment.

The melting point of the synthetic polymer fibers may sometimes be substantially not observed. This is because some synthetic polymer fibers may undergo thermal decomposition or thermosetting upon heating and temperature elevation, without melting or almost simultaneously with melting. In an embodiment of the present invention, synthetic polymer fibers substantially having no observed melting point can be used as long as the synthetic polymer fibers satisfy a condition that the synthetic polymer fibers do not melt at the decomposition temperature of the cellulosic fibers used with the synthetic polymer fibers or lower.

Furthermore, for some polymer materials, such as synthetic polymer fibers, it may be difficult to determine a single melting point even for a single product, and in light of the common technical knowledge in the relevant technical field, their melting points may be determined within certain numerical ranges. Therefore, in a case where one or both of the thermal decomposition temperature of the cellulosic fibers and the melting point of the synthetic polymer fibers is/are represented by a numerical range or numerical ranges, a comparison using the thermal decomposition temperature or melting point as an index is made using the numerical ranges of both of them or the numerical range of one of them. In such a case, in a preferred embodiment of the present invention, the largest value (or the upper limit value) of the numerical range can be used for comparison with respect to the thermal decomposition temperature of the cellulosic fibers and the smallest value (or the lower limit value) of the numerical range can be used for comparison with respect to the melting point of the synthetic polymer fibers.

Examples of preferred types of the synthetic polymer fibers may include aramid fibers, polyether ether ketone fibers, polyimide fibers, and polyphenylene sulfide fibers, and more preferably, the examples may include aramid fibers, polyimide fibers, and polyphenylene sulfide fibers. One type of synthetic polymer fibers may be used or two types of synthetic polymer fibers may be used in combination. A material having thermal properties contributing more to reduction of shrinkage of the cellulosic fibers upon carbonization treatment can be obtained from these synthetic polymer fibers.

The shape of the caron material precursor is not particularly limited. Examples of an embodiment of the carbon material precursor may include a sheet-shaped carbon material precursor or a roll-shaped carbon material precursor obtained by rolling the sheet-shaped carbon material precursor. The carbon material precursor can be easily handled and transported and can also be easily transferred to a later manufacturing process.

In a case where the precursor including the cellulosic fibers as a main component is sheet-shaped, the influence of the shrinkage upon carbonization treatment may be large. A carbon material precursor that is an embodiment of the present invention enables reduction in shrinkage upon carbonization treatment even though the carbon material precursor includes cellulosic fibers as a main component and a sheet-shaped carbon material precursor may thus be a preferred form of application of the present invention.

The carbon material precursor may be composed of the unfired fiber mixture only but according to the use of the obtained carbon material and the performance required of the carbon material, any other component may additionally be mixed therein. For example, a catalyst for promoting the progress of carbonization by firing may be added. Furthermore, a binder may be mixed therein to improve shape stability of the carbon material precursor or the carbon material obtained by carbonization of the carbon material precursor. Furthermore, examples of the other component may include a conductive additive, a metal catalyst, and a surfactant.

### 2. Method of Manufacturing Carbon Material Precursor

A carbon material precursor that is an embodiment of the present invention includes cellulosic fibers and another unfired material that may reduce shrinkage of the cellulosic fibers. Examples of the other unfired material may include, as mentioned above, synthetic polymer fibers having given thermal properties.

As an embodiment of the present invention, the carbon material precursor can be obtained by mixing the cellulosic fibers and the synthetic polymer fibers together to thereby prepare an unfired fiber mixture. From the viewpoint of reducing shrinkage of the cellulosic fibers upon carbonization treatment, a state is preferably formed, the state being a state where the cellulosic fibers and the synthetic polymer fibers are both dispersed in the unfired fiber mixture and the cellulosic fibers and the synthetic polymer fibers are entangled with each other. It can be expected that the mutual entanglement of these fibers will cause, during carbonization treatment by firing, the synthetic polymer fibers to act as a support that inhibits the shrinkage of the cellulosic fibers when a temperature range in which the cellulosic fibers tend to shrink is reached.

To sufficiently mix the cellulosic fibers and the synthetic polymer fibers together, in an embodiment, for example, the unfired fiber mixture may be prepared as follows. The cellulosic fibers and the synthetic polymer fibers are respectively added to dispersion media, such as water or aqueous solutions, and a defibrated slurry of the cellulosic fibers and a defibrated slurry of the synthetic polymer fibers are thereby prepared. For sufficient defibration and dispersion, a retention agent, a surfactant, and/or a thickener, for example, may be added. By mixing these defibrated slurries together and stirring the mixed slurries, a mixed slurry including both of these types of fibers that have been sufficiently mixed together is prepared. Furthermore, as needed, any other component may be added to each of these defibrated slurries or to the mixed slurry and stirred and mixed therein. The obtained mixed slurry is poured into a desired mold, for example, the dispersion medium is removed by drying, and an unfired fiber mixture of a desired shape can thereby be prepared.

### 3. Method of Manufacturing Carbon Material

By firing to carbonize the carbon material precursor, a carbon material can be obtained. In an embodiment of the present invention, the carbon material precursor is subjected to heat treatment at a given temperature or higher in an inert gas atmosphere, thus being subjected to firing.

An inert gas atmosphere means an oxygen-free or low-oxygen atmosphere in which carbon is unlikely to undergo a combustion reaction but is carbonized. In an embodiment of the present invention, examples of the inert gas may include helium gas, argon, and nitrogen. Among these examples, nitrogen may be preferred from the viewpoint of manufacturing cost.

In an embodiment of the present invention, a heating temperature (the highest temperature reached) for firing the carbon material precursor may preferably range from 700 to 2500° C. More specifically, the heating temperature is as follows.

The lower limit of the heating temperature (the highest temperature reached) for firing the carbon material precursor may be preferably 700° C. or higher, more preferably 750° C. or higher, and even more preferably 800° C. or higher. Heating the carbon material precursor to such temperatures or higher allows the carbon material precursor to be carbonized sufficiently.

From the viewpoint of firing the carbon material precursor, the highest temperature reached by the heating has no particular upper limit, but from the viewpoint of manufacturing cost, the highest temperature reached by the heating may be preferably about 2500, 2300, 2000, 1800, or 1500° C. or lower.

In one embodiment of the present invention, the heating rate of the heating in the process of firing the carbon material precursor may be preferably 3 to 45° C./min or less. More specifically, the heating rate is as follows.

The lower limit of the heating rate in the firing process may be preferably 3° C./min or higher, more preferably 5 or 10° C./min or higher, and even more preferably 15° C./min or higher. The lower limit of the heating rate being at these values enables the firing process to be implemented without aimlessly taking a long period of time while reducing shrinkage of the precursor including the cellulosic fibers as a main component.

The upper limit of the heating rate in the firing process may be preferably 45° C./min or less, more preferably 40 or 35° C./min or less, and even more preferably 30° C./min or less. By having the upper limit of the heating rate at these values, excessively rapid heating can be avoided and this contributes to reduction in shrinkage of the precursor including the cellulosic fibers as a main component.

In a method of manufacturing the carbon material, the method being an embodiment of the present invention, instead of mixing cellulosic fibers with a carbon material obtained by carbonization beforehand and performing a firing process again, that is, instead of performing a firing process twice or more, an end product, which is the carbon material, can be manufactured by a single firing process from a precursor including cellulosic fibers as a main component, and what is more, shrinkage of the precursor in that process can be reduced. Therefore, according to one or more embodiments of the present invention, the manufacturing cost and the number of manufacturing steps are able to be reduced.

### EXAMPLES

The present invention will hereinafter be described more specifically by reference to Examples but the technical scope (or technical range) of the invention presented by the present disclosure is not to be limited to Examples below. Methods, such as measurement methods, calculation methods, and evaluation methods, described hereinafter, can be used as ways of finding numerical values in a case where the invention presented by the present disclosure is determined using the numerical values.

“Thermal decomposition temperatures” and “melting points” in the present disclosure can be found by the following methods.

### Determination of Thermal Decomposition Temperature

In a case where a thermal decomposition temperature was indicated as a reference specification of a product, that value was used, and in a case where there was no indication, a temperature range in which significant weight reduction occurred when heating was performed at 10° C./min in a nitrogen atmosphere using a thermogravimetric analysis (TGA) apparatus was determined as the thermal decomposition temperature. A “temperature range in which significant weight reduction occurs” can be determined as a temperature range from a starting point of the significant weight reduction to an ending point of the significant weight reduction.

### Determination of Melting Point (Tm)

In a case where a melting point was indicated as a reference specification of a product, that value was used, and in a case where there was no indication, the peak-top temperature of melting upon heating at 10° C./min in a nitrogen atmosphere using a differential scanning calorimeter (DSC) was determined as the melting point.

### Example 1

Conifer-derived chemical pulp (needle unbleached kraft pulp: NUKP) in an amount of 16 g on an absolute dry weight basis and 1 mm cut aramid fibers (Kevlar 49, manufactured by Du Pont-Toray Co., Ltd. and having a thermal decomposition temperature of 539° C., where “Kevlar” is a registered trademark) in an amount of 4 g on an absolute dry weight basis were dispersed in water, water was further added to bring the total weight to approximately 2 kg, and a first slurry was thereby prepared. A second slurry was prepared by subjecting the first slurry to disintegration using a TAPPI disintegrator, and using half of the second slurry, a 25 cm×25 cm handmade sheet was prepared with a standard handmade paper making machine. The obtained sheet was dried using a cylinder dryer set at 100° C., was thereafter subjected to humidity control for 24 hours in an environment at 23° C. and humidity of 50%, and a carbon material precursor sheet was thereby obtained.

### Comparative Example 1

A carbon material precursor sheet was obtained by a process in the same manner as that of Example 1, except that conifer-derived chemical pulp (needle unbleached kraft pulp: NUKP) in an amount of 20 g on an absolute dry weight basis was dispersed in water, water was further added to bring the total weight to approximately 2 kg, and a first slurry was thereby prepared.

### Comparative Example 2

A carbon material precursor sheet was obtained by a process in the same manner as that of Example 1 except that conifer-derived chemical pulp (needle unbleached kraft pulp: NUKP) in an amount of 16 g on an absolute dry weight basis and PE pulp (having a mean fiber length of 1.2 mm, SWP manufactured by Mitsui Chemicals, Inc., having a melting point ranging from 125 to 137° C., where “PE” is an abbreviation for polyethylene and “SWP” is a registered trademark) in an amount of 4 g on an absolute dry weight basis were dispersed in water, water was further added to bring the total weight to approximately 2 kg, and a first slurry was thereby prepared.

### Comparative Example 3

A carbon material precursor sheet was obtained by a process in the same manner as that of Example 1 except that conifer-derived chemical pulp (needle unbleached kraft pulp: NUKP) in an amount of 8 g on an absolute dry weight basis, mechanical pulp (collected from a pulp preparation process at newsprint manufacturing equipment of Nippon Paper Industries Co., Ltd.) in an amount of 8 g on an absolute dry weight basis, and PE pulp (having a mean fiber length of 1.2 mm, SWP manufactured by Mitsui Chemicals,

Inc.) in an amount of 4 g on an absolute dry weight basis were dispersed in water, water was further added to bring the total weight to approximately 2 kg, and a first slurry was thereby prepared.

### Shrinkage Test

Two 10×10 cm test sheets were cut out from each of the sheets of Example 1 and Comparative Examples 1 to 3. The sheets cut out were placed in a firing furnace, heated to 900° C. at a heating rate of 15°/min, and fired for 60 minutes at temperatures around 900° C. A length of one side of each sheet fired was measured, and a mean value was found for each of the example and comparative examples. Results of the measurement are listed in Table 1.

### Table 1

TABLE 1
Compositions of Precursors and Shrinkage Test Results

| | | | | | Shrinkage before and after firing at 900° C. | | |
|---|---|---|---|---|---|---|---|
| | | | | | | B: Length of | |
| | Composition of whole sheet (% by weight) | | | | A: Length of one | one side of | |
| | Chemical pulp | Mechanical pulp | Aramid fiber | | side of precursor | sheet after firing | |
| | (NUKP) | (GP) | (Kevlar) | PE fiber | sheet (cm) | (cm) | B/A (%) |
| Thermal decomposition | 250 to 350 | 250 to 350 | 539 | 300 to 400 | | | |
| temperature (° C.) | | | | | | | |
| Melting point (° C.) | Not observed | Not observed | Not observed | 125 to 137 | | | |
| Example 1 | 80 | 0 | 20 | 0 | 10 | 8.8 | 88.0 |
| Comparative Example 1 | 100 | 0 | 0 | 0 | 10 | 7.4 | 74.0 |
| Comparative Example 2 | 80 | 0 | 0 | 20 | 10 | 7.2 | 72.0 |
| Comparative Example 3 | 40 | 40 | 0 | 20 | 10 | 7.3 | 73.0 |

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A carbon material precursor, comprising:
an unfired fiber mixture of cellulosic fibers and synthetic polymer fibers;
a content of 50% by weight or more of the cellulosic fibers in the unfired fiber mixture;
a content of 5% by weight or more and less than 50% by weight of the synthetic polymer fibers in the unfired fiber mixture; and
the synthetic polymer fibers having a thermal decomposition temperature higher than a thermal decomposition temperature of the cellulosic fibers, and remaining unmelted at the thermal decomposition temperature of the cellulosic fibers or lower.

2. The carbon material precursor according to claim 1, wherein the cellulosic fibers include any one selected from or both of chemical pulp and mechanical pulp.

3. The carbon material precursor according to claim 1, wherein the thermal decomposition temperature of the synthetic polymer fibers is 350° C. or higher in an inert gas atmosphere, at a heating rate of 10° C./min.

4. The carbon material precursor according to claim 1, wherein the synthetic polymer fibers have a melting point of 350° C. or higher or no observed melting point.

5. The carbon material precursor according to claim 1, wherein the synthetic polymer fibers are one type or two or more types selected from a group consisting of aramid fibers, polyether ether ketone fibers, polyimide fibers, and polyphenylene sulfide fibers.

6. The carbon material precursor according to claim 1, wherein
the cellulosic fibers include any one selected from or both of chemical pulp and mechanical pulp; and
the synthetic polymer fibers are one type or two or more types selected from a group consisting of aramid fibers, polyether ether ketone fibers, polyimide fibers, and polyphenylene sulfide fibers.

7. The carbon material precursor according to claim 6, wherein the thermal decomposition temperature of the synthetic polymer fibers is 350° C. or higher in an inert gas atmosphere, at a heating rate of 10° C./min.

8. The carbon material precursor according to claim 6, wherein the synthetic polymer fibers have a melting point of 350° C. or higher or no observed melting point.

9. A method of manufacturing a carbon material, the method including:
a process of firing a carbon material precursor, wherein
the carbon material precursor includes an unfired fiber mixture of cellulosic fibers and synthetic polymer fibers, a content of the cellulosic fibers in the unfired fiber mixture is 50% by weight or more, and a content of the synthetic polymer fibers in the unfired fiber mixture is 5% or more and less than 50%, and
the synthetic polymer fibers have a thermal decomposition temperature higher than a thermal decomposition temperature of the cellulosic fibers, and remain unmelted at the thermal decomposition temperature of the cellulosic fibers or lower.

10. The method of manufacturing the carbon material, according to claim 9, wherein the carbon material precursor is sheet-shaped and the carbon material is a carbon fiber sheet.

11. The method of manufacturing the carbon material, according to claim 9, wherein the firing is performed at a temperature ranging from 700 to 2500° C.

12. The method of manufacturing the carbon material, according to claim 9, wherein in the process of firing, a heating rate up to a highest temperature is 45° C./min or less.

13. The method of manufacturing the carbon material, according to claim 9, wherein
the firing is performed at a temperature ranging from 700 to 2500° C., and
in the process of firing, a heating rate up to a highest temperature is 45° C./min or less.

14. The method of manufacturing the carbon material, according to claim 9, wherein
the carbon material precursor is sheet-shaped and the carbon material is a carbon fiber sheet,
the firing is performed at a temperature ranging from 700 to 2500° C., and
in the process of firing, a heating rate up to a highest temperature is 45° C./min or less.
